(19) United States
(12) Patent Application Publication
(10) Pub. No.: US 2007/0137419 A1
(43) Pub. Date: Jun. 21, 2007

(54) Twin pedal assembly for a bass drum

(76) Inventor: Kuo-Hua Chen, Taichung Hsien (TW)

Correspondence Address: PATENTTM.US, P. O. BOX 82788, PORTLAND, OR, 97282-0788, US

(21) Appl. No.: 11/274,370

(22) Filed: Nov. 14, 2005

(51) Int. Cl. G05G 1/16

(52) U.S. Cl. 74/562

(57) ABSTRACT

A twin pedal assembly for a bass drum includes a first pedal and a second pedal. A linkage is connected between the first pedal and second pedal and has a bar. A passage is defmed through the bar. Multiple threaded holes are defmed through an upper side of the bar inclined towards a user. Multiple threaded fasteners are screwed into the threaded holes and inclined towards the user. Two shafts are inserted respectively into the passage and secured by the fasteners. Two universal joints are mounted respectively between free ends of the shafts and the pedals. Each universal joint is composed of a first barrel connected to the shaft, a second barrel connected to the first pedal/second pedal and a pin to pivotally mounted between the first barrel and second barrel. Whereby, it is very easy and convenient to loosen/tighten the fasteners to adjust a distance between the pedals.

### BACKGROUND OF THE INVENTION

1. Field of the Invention

The present invention relates to a twin pedal assembly for a bass drum, and more particularly to a twin pedal assembly, which can be conveniently adjusted and has a reliable transmission effect.

2. Description of the Related Art

With reference to FIG. 4, a conventional twin pedal assembly for a bass drum includes a first pedal (80), a second pedal (90) and a linkage (70) to connect the two pedals (80, 90). A first beater (50A) is mounted on the linkage (70) and operated by the first pedal (80), and a second beater (SOB) is operated by the second pedal (90).

The linkage (70), as illustrated in FIG. 5, includes a bar (71) with a substantially rectangular cross section. A passage (711) with a hexagonal cross section is longitudinally defined through the bar (71). Multiple threaded holes (714) are defined respectively on an upper side of the bar (71) adjacent to two ends of the bar (71) and in communication with the passage (711). Multiple threaded fasteners (713) are screwed into the threaded holes (714).

Two shafts (72), each with a hexagonal cross section, are inserted into the passage (711) through the two ends of the bar (71), respectively. The shafts (72) are secured in the passage (711) by the fasteners (713).

Two universal joints (73) are mounted respectively between free ends of the shafts (72) and the pedals (80, 90). Each universal joint (73) is composed of two barrels (731). Each barrel (731) has a pair of ears (733). The barrels (731) are pivotally connected to each other by a pin extending through the ears (733).

Thus, when the first pedal (80) is pressed downward, the linkage (70) rotates to operate the first beater (50A); when the second pedal (90) is pressed downward, the second beater (50B) is operated directly. When the pedals (80, 90) are not pressed, the upper side of the bar (71) is substantially horizontal.

A distance between the pedals (80, 90) is adjustable to adapt to various users. For adjustment, the fasteners (713) are loosened so the shafts (72) can be pulled out of or inserted into the passages (711) at various lengths to change the distance between the pedals (80, 90).

However, with reference to FIG. 6, because the upper side of the bar (71) is substantially horizontal, the fasteners (713) are substantially vertical. When a user in a sitting position wants to adjust the pedals (80, 90), the user's hand is not in proper alignment to turn the fasteners (713). Thus, it is very inconvenient for the user to loosen/tight the fasteners (713).

Moreover, the barrels (731) of the universal joints (73) are respectively connected to the shafts (72) and transmitting shafts (not numbered) on the pedals (80, 90). When the first pedal (80) is pressed, the two barrels (731) are pivoted to each other to define an included angle between them. If the included angle between the two barrels (731) is large, the first pedal (80) can be easily pressed to operate the first beater (50A). On the other hand, a small included angle may cause unreliable transmission to beat the bass drum.

Therefore, the invention provides an improved twin pedal assembly to mitigate or obviate the aforementioned problems.

### SUMMARY OF THE INVENTION

The main objective of the present invention is to provide a twin pedal assembly for a bass drum which is easy to adjust a distance between two pedals.

Another objective of the present invention is to provide a twin pedal assembly for a bass drum which has a reliable transmission effect.

Other objectives, advantages and novel features of the invention will become more apparent from the following detailed description when taken in conjunction with the accompanying drawings.

### BRIEF DESCRIPTION OF THE DRAWINGS

FIG. 1 is an operational perspective view of a twin pedal assembly in accordance with the present invention;

FIG. 2 is an exploded perspective view of a linkage of the present invention;

FIG. 3 is an operational view in partial cross section of a fastener on the linkage in FIG. 2;

FIG. 4 is an operational perspective view of a conventional twin pedal assembly;

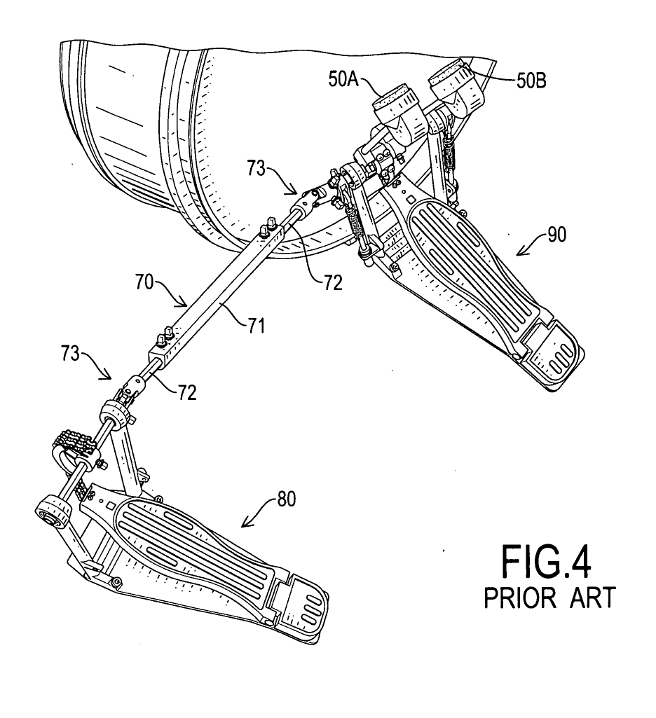

FIG. 5 is an exploded perspective view of a linkage of the conventional twin pedal assembly; and

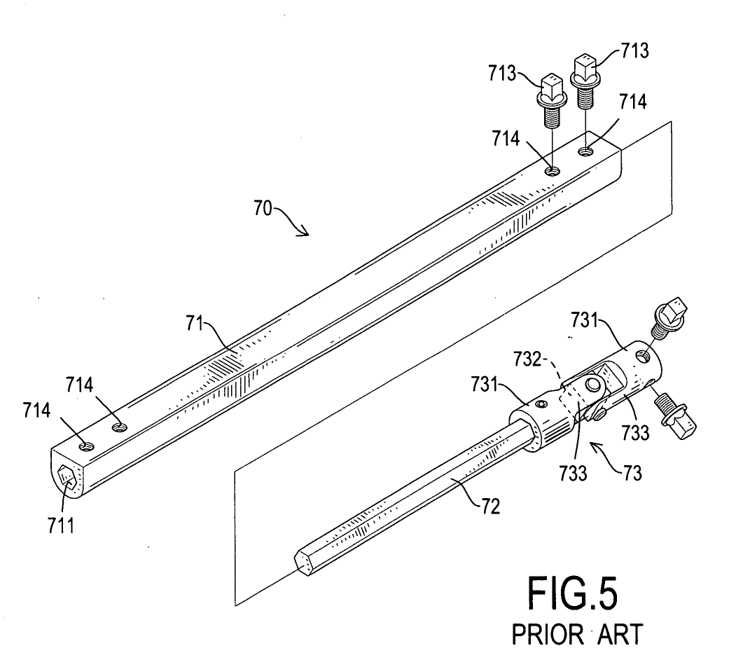

FIG. 6 is an operational view in partial cross section of a fastener on the linkage in FIG. 5.

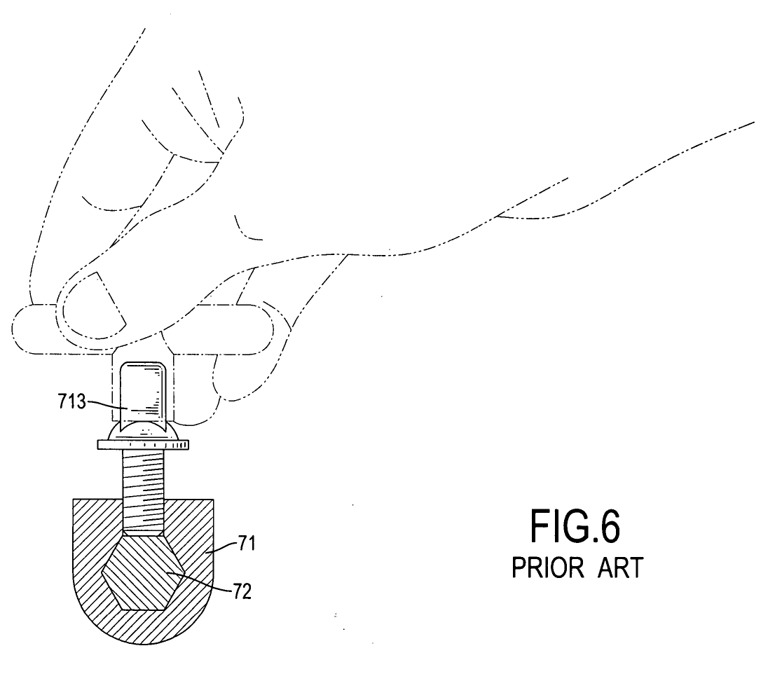

### DETAILED DESCRIPTION OF THE PREFERRED EMBODIMENT

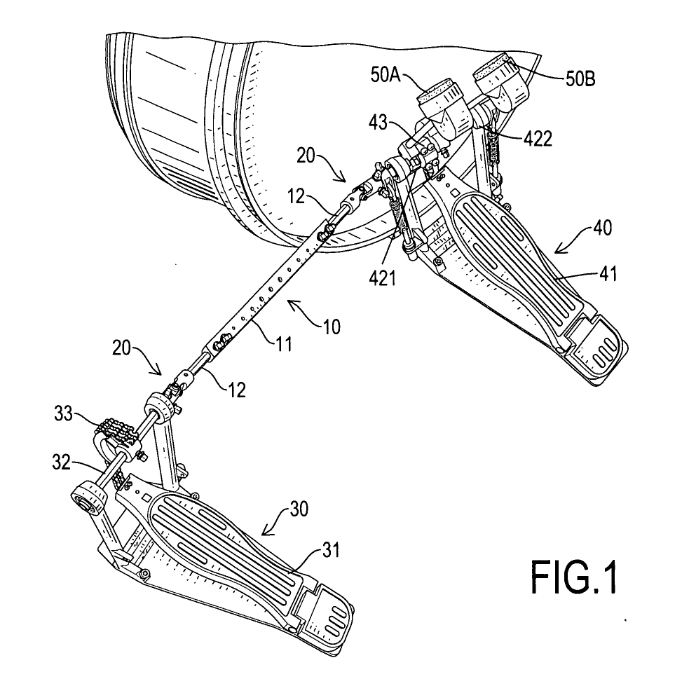

With reference to FIG. 1, a twin pedal assembly for a bass drum in accordance with the present invention has a first pedal (30), a second pedal (40) and a linkage (10) to connect the two pedals (30, 40).

The first pedal (30) has a first foot pedal (31). A first transmitting shaft (32) is provided above the first foot pedal (31). A first chain (33) is connected between the first foot pedal (31) and the first transmitting shaft (32). When the first foot pedal (31) is pressed, the first chain (33) is pulled downward to turn the first transmitting shaft (32).

The second pedal (40) has a second foot pedal (41). A second transmitting shaft (421) and a third transmitting shaft (422) are separately provided above the second foot pedal (41). A first beater (50A) is mounted on the second transmitting shaft (421), and a second beater (50B) is mounted on the third transmitting shaft (422). A second chain (43) is connected between the second foot pedal (41) and the third transmitting shaft (422). When the second foot pedal (41) is pressed, the second chain (43) is pulled downward to turn the third transmitting shaft (422).

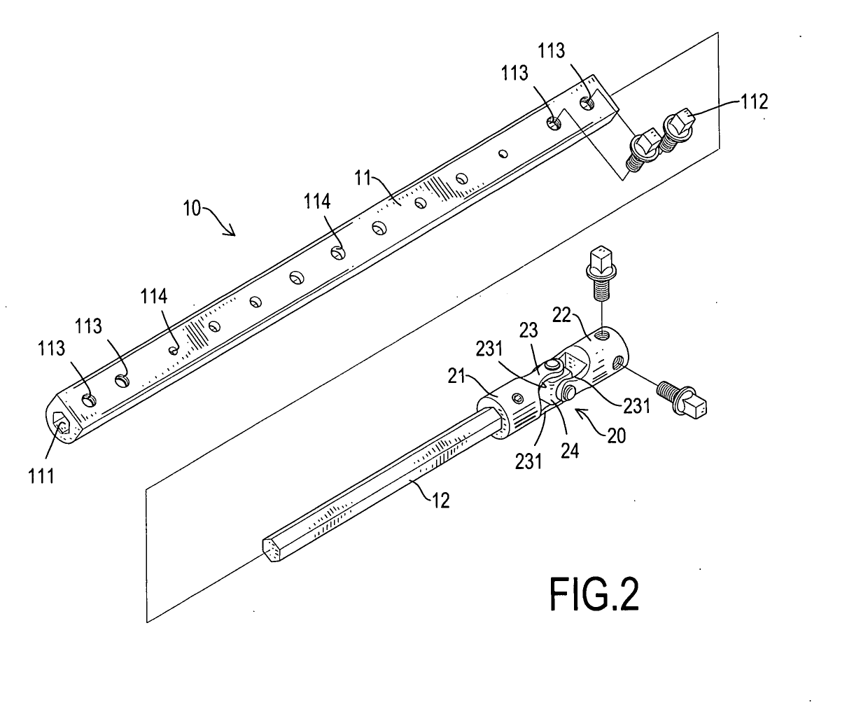

With reference to FIG. 2, the linkage (10) has a bar (11). A passage (111) with a non-circular (hexagonal in this embodiment) cross section is longitudinally defined through the linkage (10). Multiple threaded holes (113) are defined respectively on an upper side of the bar (11) adjacent two ends of the bar (11) and in communication with the passage (111). The upper side of the bar (11) is inclined towards a user's direction. Multiple threaded fasteners (112) are screwed into the threaded holes (113). Multiple holes (114) are evenly defined between the threaded holes (113)

Two shafts (12) each with a non-circular (hexagonal in this embodiment) cross section are inserted in the passage (111) through the two ends of the bar (11), respectively. The shafts (12) are secured in the passage (111) by the fasteners (112).

With reference to FIGS. 1-2, two universal joints (20) are mounted respectively between free ends of the shafts (12) and the first transmitting shaft (32) and the second transmitting shaft (421). Each universal joint (20) is composed of a first barrel (21) connected to the shaft (12) and a second barrel (22) connected to the first transmitting shaft (32) or the second transmitting shaft (421).

The first and second barrels (21, 22) each have a pair of ears (23). A pin (24) extends through the ears (23) to pivotally connect the first and second barrels (21, 22). Each of the ears (23) has two arcuate edges (231) concaved inwards respectively formed at two sides thereof. Therefore, a rotatable range of the two barrels (21, 22) is large, so the first pedal (30) can be easily pressed to operate the first beater (50A).

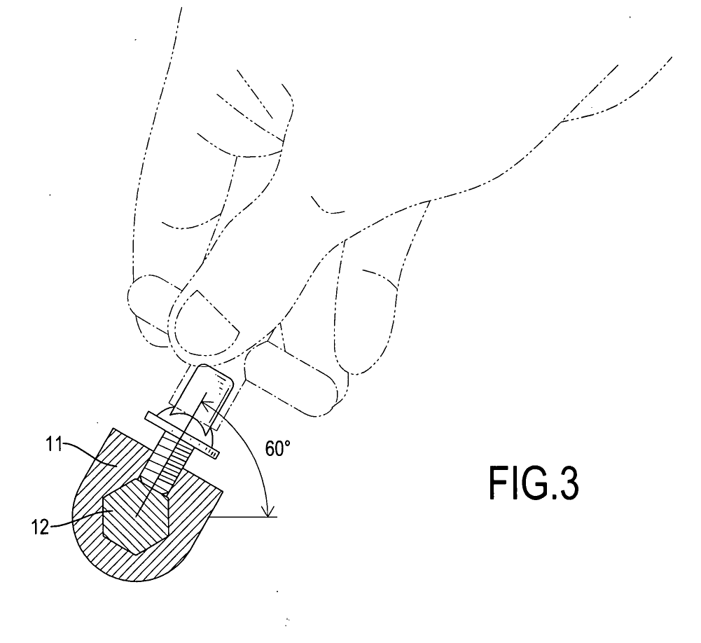

When assembled, the upper side of the bar (11) is slightly inclined towards a user, so the fasteners (112) have an included angle of 60° to the horizontal in a non-operating state, as illustrated in FIG. 3.

When the user wants to adjust the distance between the two pedals (30, 40), the user just stoops and extends his/her arm to turn the fasteners (112). Because the fasteners (112) are inclined and substantially aligned with the user's hand, it is very easy and convenient to loosen/tighten the fasteners (112).

Moreover, the user can see the length of the shafts (12) in the bar (11) by viewing through the holes (114) to prevent the shafts (12) from escaping from the bar (11) during adjustment.

Furthermore, because the universal joints (20) have a large range of rotation, the universal joints (20) can respond reliably to the operation of the first foot pedal (30).

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A twin pedal assembly for a bass drum comprising:
a first pedal (30);
a second pedal (40);
a linkage (10) connected between the first pedal (30) and second pedal (40), the linkage (10) having
a bar (11), a non-circular passage (111) longitudinally defined through the bar (11), an upper side of the bar inclined towards a user's direction; multiple threaded holes (113) defined respectively through the upper side adjacent two ends of the bar (11), multiple threaded fasteners (112) screwed into the threaded holes (113) and inclined towards the user's direction;
two shafts (12), each with a non-circular cross section, inserted respectively into the passage (111) and secured by the fasteners (112); and
two universal joints (20) respectively mounted between free ends of the shafts (12) and the pedals (30, 40), each universal joint (20) being composed of a first barrel (21) connected to the shaft (12), a second barrel (22) connected to the first pedal (30)/second pedal (40) and a pin (24) to pivotally mount the first barrel (21) and second barrel (22).

2. The twin pedal assembly as claimed in claim 1, wherein the barrels (21, 22) each have a pair of ears (23) pivotally connected to each other by the pin (24), and each of the ears (23) has an arcuate edge (231) concaved inwards.

3. The twin pedal assembly as claimed in claim 1, wherein the bar (11) has multiple holes evenly defined through the upper side and between the multiple fasteners (112).

4. The twin pedal assembly as claimed in claim 2, wherein the bar (11) has multiple holes evenly defmed through the upper side and between the multiple fasteners (112).

5. The twin pedal assembly as claimed in claim 3, wherein the cross section of the passage (111) is hexagonal; and the cross section of the shaft (12) is hexagonal.

6. The twin pedal assembly as claimed in claim 4, wherein the cross section of the passage (111) is hexagonal; and the cross section of the shaft (12) is hexagonal.

7. The twin pedal assembly as claimed in claim 5, wherein the fasteners (112) have an included angle of 60° to the horizontal.

8. The twin pedal assembly as claimed in claim 6, wherein the fasteners (112) have an included angle of 60° to the horizontal.

9. The twin pedal assembly as claimed in claim 1, wherein the fasteners (112) have an included angle of 60° to the horizontal.

10. The twin pedal assembly as claimed in claim 2, wherein the fasteners (112) have an included angle of 60° to the horizontal.
